(19) United States
(12) Patent Application Publication
(10) Pub. No.: US 2007/0109112 A1
(43) Pub. Date: May 17, 2007

(54) Machine body antenna

(75) Inventors: Tae Ri Lee, Delta (CA); Gordon Graham Schnare, Vernon (CA); Michael Boudreau, Salmon Arm (CA)

Correspondence Address: ANTONY C. EDWARDS, SUITE 200 - 270 HIGHWAY 33 WEST, KELOWNA, BC, V1X 1X7, CA

(73) Assignee: SST WIRELESS INC., Kelowna, BC (CA)

(21) Appl. No.: 10/578,504

(22) PCT Filed: Nov. 17, 2004
(86) PCT No.: PCT/CA04/01973

§ 371 Date: May 5, 2006

Related U.S. Application Data
(60) Provisional application No. 60/481,654, filed on Nov. 17, 2003.

(51) Int. Cl. B60C 23/00

(52) U.S. Cl. 340/447

(57) ABSTRACT

A communication antenna for communications with a near field device using at least one transmitter and receiver pair, wherein the antenna includes a machine body antenna which is electrically isolated from ground and includes an electrically conductive machine frame, and which, when in electrical communication with one transmitter or receiver element of the transmitter and receiver pair, is excited so as to enable communication between the transmitter and receiver pair when the other of the transmitter or receiver elements is in electrical communication with the near field device and mounted within the near field of the machine body antenna without being in contact with the machine body antenna.

### FIELD OF THE INVENTION

This invention relates to antennas used in the transmission and reception of electromagnetic radiation in the radio spectrum for the purpose of wirelessly conveying information from one location to another. More specifically this relates to communication between a centralized system or systems and one or more sensors in proximity to the machine body.

### BACKGROUND OF THE INVENTION

It is known that when using wireless devices and sensor systems on machines for accurate monitoring and control of aspects of the machine, that line of sight transmission is not always possible, leading, for example, to signal blockage and consequential increased transmission power requirements for the sensors and the interrogating node(s).

It is also known that all that is required to emit electromagnetic waves is electrons in motion.

A dipole antenna is basically a resonant narrow-band device, with a marked bi-directional pattern. A loop antenna is essentially a magnetic field receiving device, the sensitivity of which is a function of area and the number of turns. Loop antennas suffer significant losses due to re-radiation. Electrostatic antennas, using solid flat plates are used for reception of electromagnetic waves, and are effective only in that part of the electromagnetic spectrum where the capacity reactance of the solid plate matches the transmission line.

Applicant is aware of the following patents regarding such antennas:

Lamberty, U.S. Pat. No. 3,050,730, which describes a number of high frequency un-tuned antennae composed of a plurality of generally rectangular plates of conducting material in various planes; Marko, U.S. Pat. No. 5,184,143 which describes a low profile antenna including a rectangular driven element; Sheriff, U.S. Pat. No. 4,975,713 which describes a planar antenna using a conductive panel-shaped open-weave mesh element in conjunction with a solid planar conductive element; Ross, U.S. Pat. No. 3,728,632 which describes an ultra wide band antenna in an electromagnetic signal communication system using short base-band pulse signals.

Further, and relative to one aspect of the present invention as it relates to use on a vehicle such as an automobile, applicant is also aware of various attempts in the prior art to mount antennas in proximity to a vehicle body, although none of which teach nor suggest the use of a machine body antenna as taught herein. In particular, U.S. Pat. No. 4,717,920 to Ohe et al. discloses an automobile antenna system integrally mounted on the vehicle body so as to detect high frequency surface currents induced on the vehicle body by broadcast waves, and wherein a high frequency pick-up has a loop antenna and a core around which the loop antenna is wound, the pick-up secured to a position on the vehicle body. U.S. Pat. No. 4,804,967 also to Ohe et al. describes an antenna system having a metallic member extending along the vehicle body and insulated from the vehicle frame where an antenna element is disposed in close proximity to the metallic member. U.S. Pat. No. 4,811,024 also to Ohe et al. discloses an automobile antenna which includes a high frequency pick-up device on a vehicle body pillar. U.S. Pat. No. 4,823,141 also to Ohe et al. discloses a vehicle antenna having a loop antenna longitudinally disposed in close proximity to a marginal edge of the vehicle body. U.S. Pat. No. 4,887,089 to Shibata et al. discloses a microstrip antenna having a radiating conductor and a grounding conductor on both sides of a dielectric substrate, the antenna mounted on a roof surface of an automobile. U.S. Pat. No. 5,161,255 to Tsuchiya discloses a microstrip antenna having a dielectric material that forms part of a motor vehicle body shell. U.S. Pat. No. 5,717,135 to Fiorletta et al. discloses a wireless tire pressure monitoring system wherein a transducer attached to a wheel rim produces a magnetic field in response to changes in tire pressure, a sensor sensing the magnetic field producing an output coupled to a monitor in the vehicle. U.S. Pat. No. 5,926,142 to Rathgeb et al. discloses a vehicle antenna device mounted into the fender of a vehicle so as to be insulated from the fender. U.S. Pat. No. 5,959,581 to Fusinski discloses a vehicle patch antenna mounted close to the conductive roof panel on an interior surface of the vehicle windshield or back glass. U.S. Pat. No. 5,959,584 to Gorham et al. discloses a vehicle having at least one antenna disposed substantially at a top site of the vehicle and at least one antenna disposed substantially at a bottom site of the vehicle to provide antenna coverage irrespective of the spatial orientation of the vehicle for example in the event of a vehicle roll-over. U.S. Pat. No. 6,011,518 to Yamagishi et al. discloses a vehicle antenna incorporated into an integrated body so as to be mounted between a mirror and a cover and mountable into a vehicle adjacent the windshield. U.S. Pat. No. 6,252,498 to Pashayan, Jr. discloses the use of receiving antennas in a pressure detector system for vehicle tires wherein the antennas are placed adjacent to each tire. U.S. Pat. No. 6,292,149 to Endo et al. discloses the use of a thin-film conductor formed on a vehicle window forming a slot between the conductive window frame and the thin-film conductor so that the slot functions as a slot antenna element. U.S. Pat. No. 6,609,419 to Bankart et al. discloses a wireless coupling such as two opposed plate-form antennae for use in an in-vehicle tire pressure sensing system.

### SUMMARY OF THE INVENTION

In one embodiment, the transmitter of a tire pressure sensor module mounted in a tire of an automobile consumes a significant amount of the battery capacity. In order to recover the correct tire pressure readings embedded in the RF signal from the module, sufficient output power must be received at the master module transceiver located inside the vehicle. One of the main obstacles for the RF transmission is the presence of the body of the automobile which acts as grounded metal shields blocking and reflecting the RF signal away from the receiver module inside. Hence the sensor module transmitter requires significantly more RF signal power than usual line of sight transmission path. This, in turn, translates into more battery capacity requirements.

The present invention provides for wirelessly communicating between one or more devices mounted in proximity or in the near-field, as defined herein, to a machine or machine body such as an automobile body, taking advantage of the machine body as a radiating element in order to reduce the emitting power requirements for example of battery powered devices such as sensors so mounted, in the automobile's tires.

Although a vehicle is a three-dimensional metal object it may be simplified and modeled as a sheet of metal having an effective length of L sitting above the earth ground. This simplified model resembles a typical flat panel antenna whose resonance wavelength is half of the effective length L. Therefore, although applicant does not wish to be bound by a particular theory of operation, it is postulated that an auto-body will behave as a flat panel antenna and should radiate at RF frequency at which its effective size is a half of wavelength of the frequency.

Since the tires are always attached in proximity to the vehicle body, the received power by the tire sensors will be significant. This is true even if the machine body antenna may not be as efficient antenna as a more well-designed conventional antenna. Furthermore, because the antenna is a reciprocal device, any transmission by the tire sensors will be equally well received by the machine body antenna

For new automobiles, the machine body antenna according to the present invention may be integrated into the manufacturing process. However, for existing automobiles, the built-in cigarette lighter terminal may be used as the antenna feed/DC supply point. A RF carrier frequency, generated and amplified within the master module, is connected to the machine body via the negative terminal of the cigarette adapter. The RF carrier functions as both energy sources for the sensor modules and bi-directional data carrier.

In summary, the present invention may be characterized in one aspect as a communication system for communicating with near field devices using a machine body antenna, wherein the system includes an RF receiver element and an RF transmitter element forming an inter-communicating RF transmitter and receiver pair, a machine body antenna cooperating between the transmitter and receiver pair, and a near field device in electrical communication so as to cooperate with a first element of the transmitter and receiver pair. The machine body antenna is electrically isolated from ground and includes an electrically conductive machine frame electrically connected to, so as to cooperate with and be excited by, a second element of the transmitter and receiver pair. The first element is within a near field of the machine body antenna without being in contact with the machine body antenna. In one embodiment the first element is the transmitter of the transmitter and receiver pair and the second element is the receiver of the transmitter and receiver pair. A second embodiment is the opposite. In one embodiment the near field device is a sensor. For example, the sensor may monitor at least one physical characteristic associated with the machine body antenna such as pressure or temperature, or both in a component of the machine, such as its pneumatic tires. Advantageously then, the machine body antenna is for example the body of a vehicle.

When the machine is a vehicle having pneumatic tires, the sensor may be mountable in cooperative association with a tire valve of the vehicle. The sensor and the transmitter may be mounted in a housing, and the housing mountable to, so as to cooperate with, a base end of a valve stem of the tire valve. The housing may include a cupped upper end shaped to fit conformably over the base end of the valve stem. A cavity may be formed in the housing underneath the upper end of the housing and sized to snugly house therein the sensor and the transmitter. The transmitter may include a battery or may be powered by the radiated energy radiated from the machine body antenna. The sensor may cooperate with the base end of the valve stem via an aperture in the upper end of the housing.

In a preferred embodiment, not intended to be limiting, a processor cooperates with the second element, for example, the receiver, for processing information exchanging between the transmitter and receiver pair. The processor may include an associated display for displaying processed information correlated to the physical characteristic or plurality of characteristics or variables being monitored. In a further alternative embodiment the first and second elements are both transceivers.

Where the machine body antenna is a machine having an electrical system, the processor and the second element may be powered by a de-mountable electrical coupling to the electrical system of the machine body antenna. For example, the coupling may be adapted to removably couple with an electrical accessory power port in the vehicle, such as a cigarette lighter plug-in port in a dashboard of the vehicle.

In a further aspect, the present invention may be characterized as a communication antenna for communications with a near field device using at least one transmitter and receiver pair, wherein the antenna includes a machine body antenna which is electrically isolated from ground and includes an electrically conductive machine frame, and which, when in electrical communication with one transmitter or receiver element of the transmitter and receiver pair, is excited so as to enable communication between the transmitter and receiver pair when the other of the transmitter or receiver elements is in electrical communication with the near field device and mounted within the near field of the machine body antenna without being in contact with the machine body antenna.

### BRIEF DESCRIPTION OF THE DRAWINGS

In the drawings, similar characters of reference denote corresponding parts in each view. The drawings are briefly described for reference as follows:

FIG. 1 is a block diagram of a master module of a communication system using a machine body antenna.

FIG. 2 is a block diagram of a slave or remote wireless device in a communication system using a machine body antenna.

FIG. 3 is a block diagram of a communication system using a machine body antenna with free-air propagation of electromagnetic waves.

FIG. 4 is a simplified model of an automobile embodiment of the machine body antenna according to the present invention.

FIG. 5 is a block diagram of an embodiment of a master module connected to a machine body antenna in an automobile application.

FIG. 6 is a block diagram of an embodiment of a remote sensor for use with a system using a machine body antenna in an automobile application.

FIG. 7 is, in exploded perspective view, a conventional schraeder™-valve stem mounting onto a sensor/transmitter package and its housing.

FIG. 8 is, in top perspective view, the sensor/transmitter housing of FIG. 7.

FIG. 9 is, in partially exploded top perspective view, the sensor/transmitter package of FIG. 7.

FIG. 10 is, in bottom perspective view, the sensor/transmitter package of FIG. 7.

FIG. 11 is, in side elevation view, the sensor/transmitter package of FIG. 7.

FIG. 12 is, in front perspective view, a display/processor/receiver housing and its associated electrical plug-in for a vehicle.

FIG. 13 is, in side perspective view, a diagrammatic approximation of the machine body antenna as approximated by a metal sheet antenna.

FIG. 14 is the block diagram of FIG. 3 wherein the remote slave devices are electrically connected to the machine body antenna.

### DETAILED DESCRIPTION OF PREFERRED EMBODIMENTS

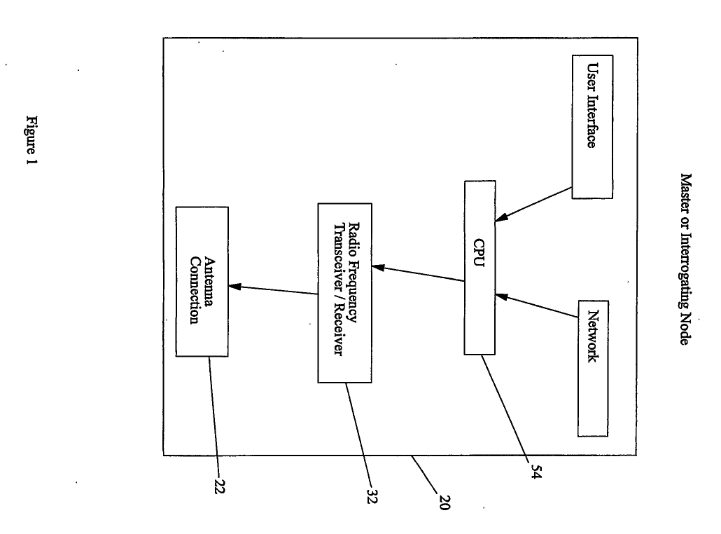

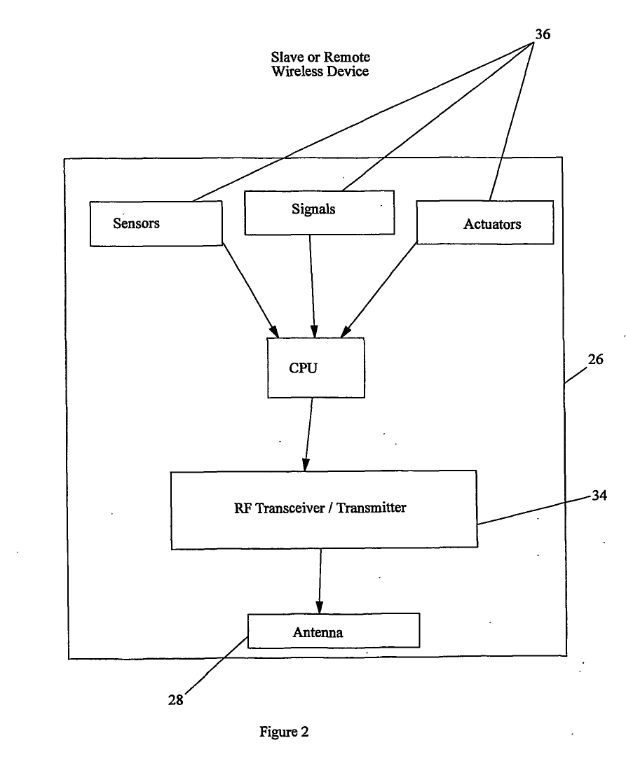

An electrically conductive machine body which is isolated from ground, for example earth ground, acts as a driven, un-tuned antenna. Applications of this include wireless communication between a central point on the machine and sensing devices mounted on or near the machine, such as in a wireless tire pressure measurement system on a motor vehicle. Such systems may include one or more master modules or interrogating nodes, such as the node shown in FIG. 1, which generally poll or monitor one or more near field slave or remote wireless devices, such as shown in FIG. 2, for sensor information, to activate remote signals, or actuate other functions.

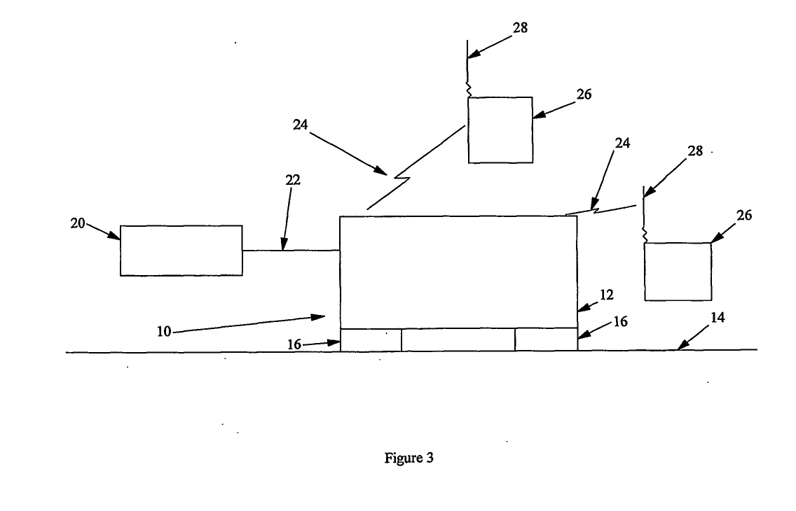

As seen in FIG. 3, the body of the machine 10 is driven by a transmitter circuit at specific or spread spectrum radio frequency(s) using modulation to induce electric currents within the machine body and thereby causing the machine body to emit electromagnetic waves. The machine body 12 is isolated from earth ground 14 by ground insulators 16. The machine body is electrically driven by master module or node 20 through electrical connector 22 so as to radiate free-air electromagnetic waves 24 to poll or command the wireless slave modules 26 through slave antenna 28. Thus RF receiver element 32 and an RF transmitter element 34 form an inter-communicating RF transmitter and receiver pair. Machine body 12 is the master antenna cooperating between the transmitter and receiver pair. A near field device 36 is in electrical communication, so as to cooperate with, a first element of the transmitter and receiver pair, shown to be transmitter 34. Near field devices 36, which may be sensors, signals or actuators to give three examples, are not themselves necessarily in the near field of machine body 12 so long as their respective transmitters, in particular the slave antennae, are in the near field to the machine body. The machine body antenna is electrically isolated from earth ground by isolators 16 and includes an electrically conductive machine frame electrically connected to, so as to cooperate with and be excited by, a second element of the transmitter and receiver pair, shown to be receiver 32. The slave antennae are within the near field of the machine body antenna without being in contact with the machine body antenna.

As shown, in one embodiment the first element is the transmitter of the transmitter and receiver pair and the second element is the receiver of the transmitter and receiver pair. Another embodiment may be the opposite.

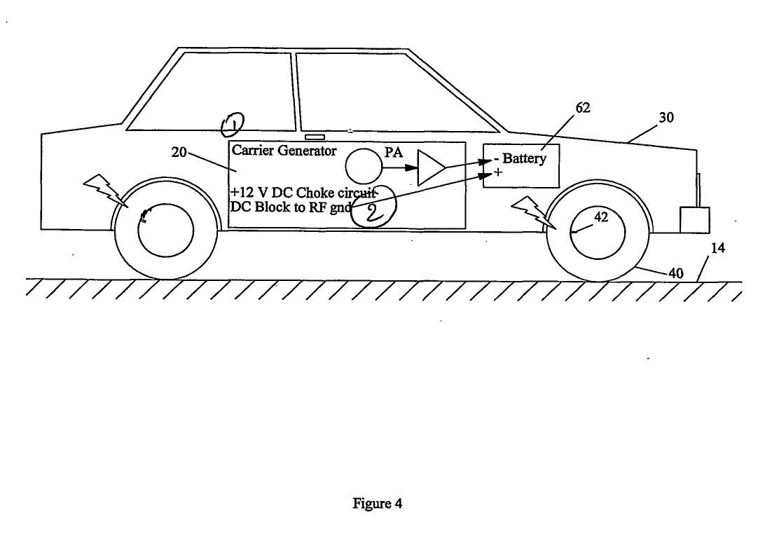

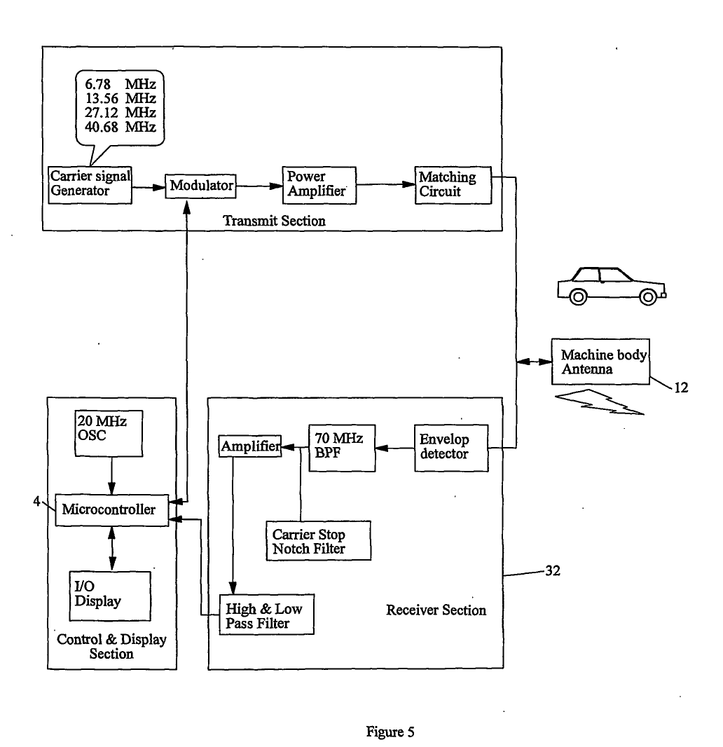

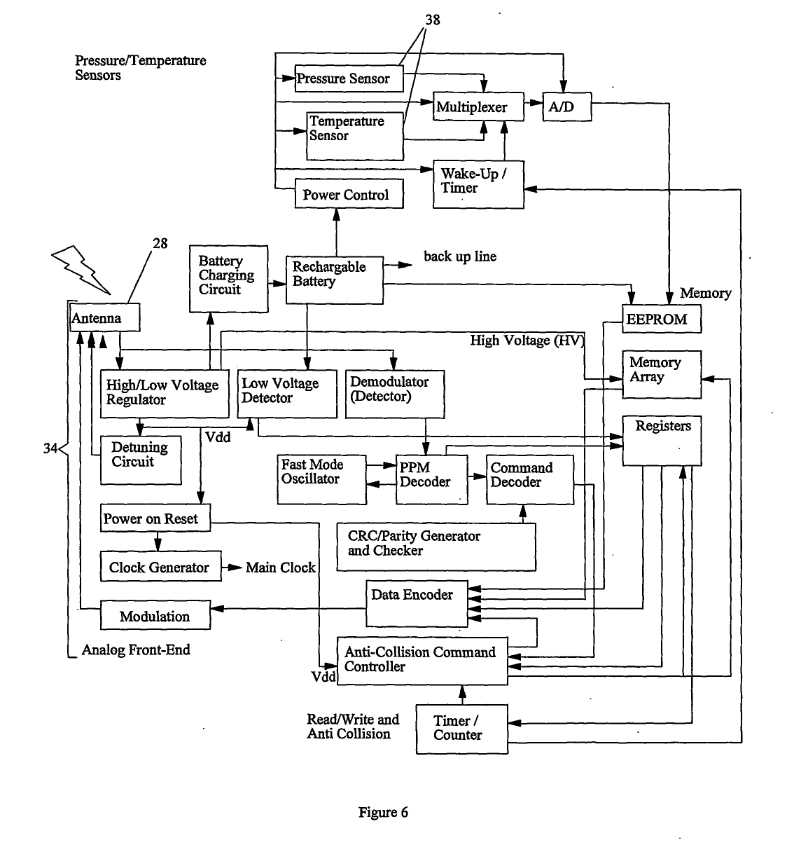

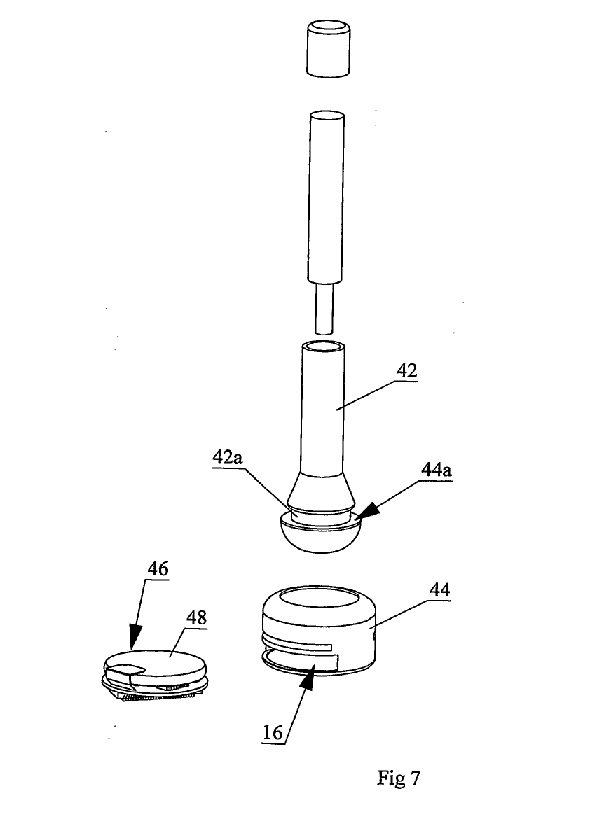

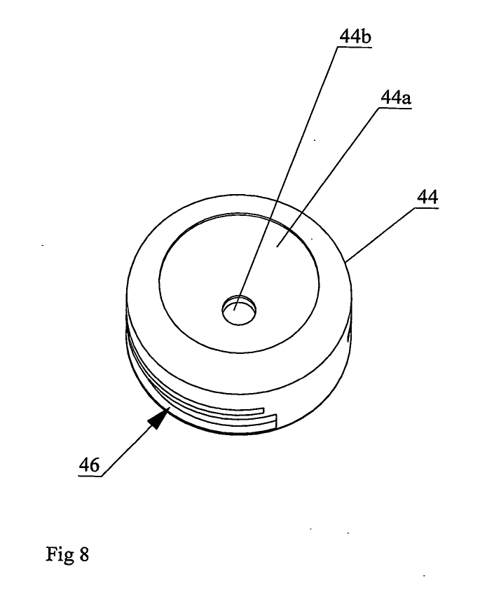

Similarly, in the motor vehicle application as shown in FIG. 4, the car body 30 acts as an antenna for transmission and reception of electromagnetic waves. The car body may be connected to a receiver circuit 32 in the master module 20 for demodulation and decoding of information being transmitted as illustrated in FIG. 5. In this example, the near field device is a sensor 38 as seen in FIG. 6. For example, the sensor may monitor at least one physical characteristic associated with the machine body antenna such as pressure or temperature, or both in pneumatic tires 40. Sensors 38 are mounted in cooperative association with tire valves 42 better seen in FIGS. 7 and 8. The sensor 38 and the transmitter 34 are mounted in a housing 44. The housing is mounted to, so as to cooperate with, base end 42a of valve stem 42. Housing 44 has a cupped upper end 44a shaped to fit conformably over the base end of the valve stem. A slot or cavity 46 is formed in the housing underneath upper end 44a and is sized to snugly house therein the sensor and transmitter package 46. Package 46 may be powered by battery 48 or may be powered by the radiated energy radiated from the machine body antenna. The package 46 cooperates with base end 42a of the valve stem via an aperture 44b in upper end 44a of the housing.

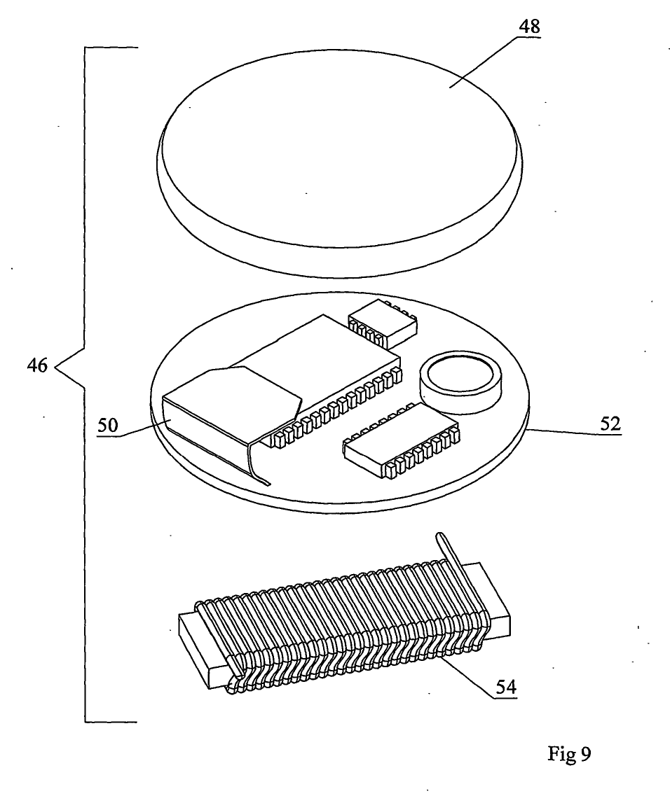

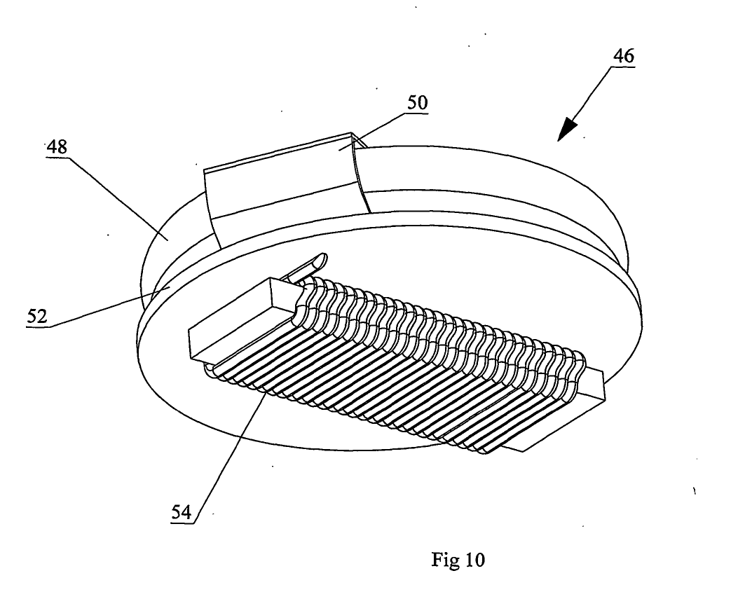

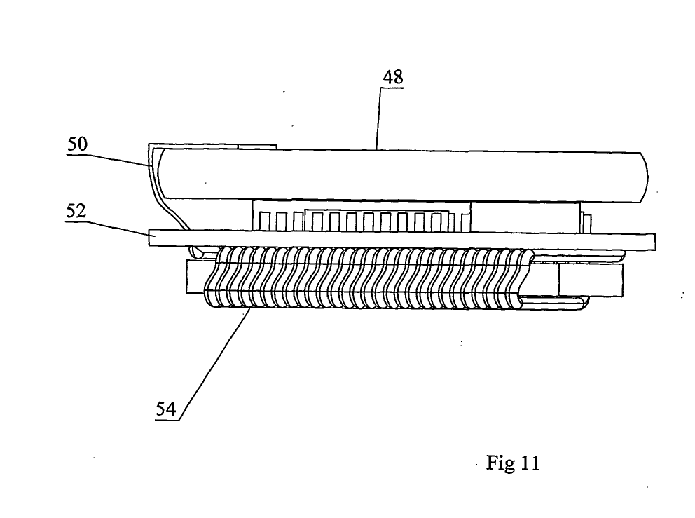

As better seen in FIGS. 9-11, the sensor and transmitter package 46 includes a deformable bracket or resilient clip 50 which assists in holding battery 48 down onto the electrical contacts on circuit board 52. Coil 54 is mounted to the opposite side of circuit board 52, opposite to battery 48.

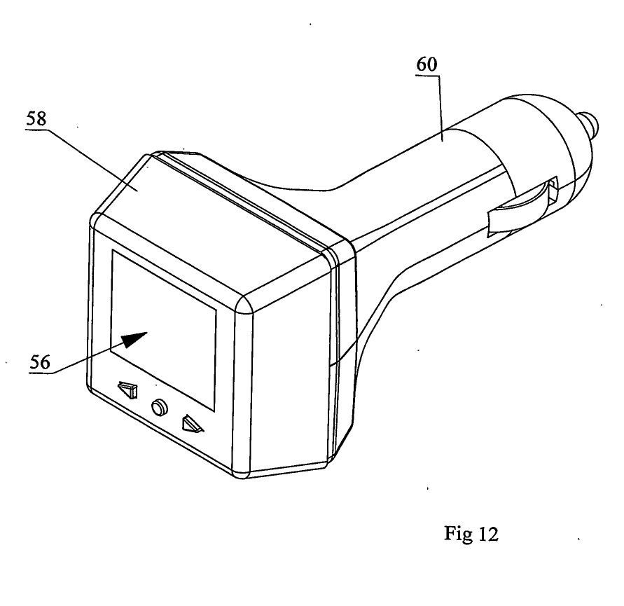

As seen in FIG. 5, which illustrates a transceiver embodiment, a processor such as microcontroller 54 cooperates with receiver 32 for processing information exchanging between the transmitter 34 and receiver 32 pair. As seen in FIG. 12 display 56 mounted in housing 58 may be associated with the processor for displaying processed information correlated to the physical characteristic or plurality of characteristics or variables being monitored.

The processor and receiver 32 may be powered by a de-mountable electrical coupling to the electrical system of the vehicle. For example, the coupling may be a 12 volt DC plug-in 60 adapted to removably couple with corresponding electrical accessory power port in the vehicle, such as a cigarette lighter plug-in port in a dashboard of the vehicle.

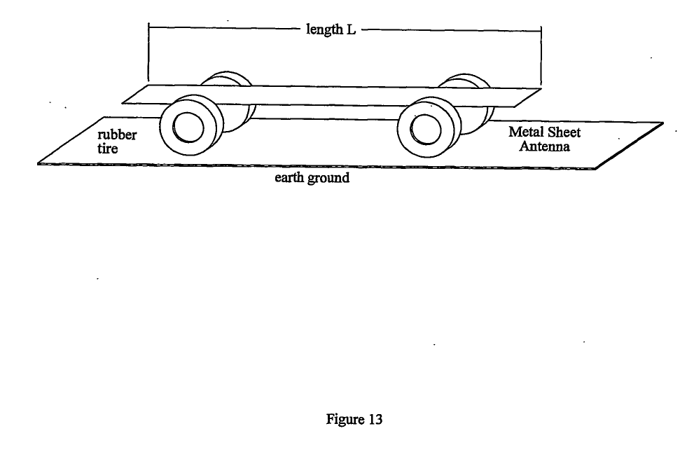

The machine body may be modeled, as may any other antenna, as a network of inductors and capacitors, and more generally may be modeled as the planar antenna shown in FIG. 13. One, and perhaps the major benefit of the machine body antenna is its distributed nature and the effectiveness achieved when communicating with radio frequency devices in proximity or in the relatively near field, including without limitation the very close or ultra-near field, (herein collectively referred to as “near field”), permitting lower transmission power requirements for the near field devices.

In the instance of a motor vehicle, which is not intended to be limiting, the body of the motor vehicle acts as an antenna. In the application of sensors such as tire pressure measurement sensors, the sensors are generally within the near field of the motor vehicle body as seen in FIG. 4. A vehicle having four tires would have a transmitter/sensor package 46 mounted to each valve stem 42. The tire pressure measurement sensor requirements are that it reliably convey tire temperature and pressure to the master module over, advantageously in a battery-powered embodiment, an operating life of at least 5 years without battery replacement. Low transmission power is thus required for the sensor. The negative terminal of the vehicle battery 62 is electrically connected to the conductive vehicle frame.

For example such sensors may transmit at a conventional frequency of 433 MHz with a wavelength of approximately 28 inches. In the prior art, the near field of an antenna is generally accepted to be within several wavelengths away from the transmitting antenna. The near field may for example be defined in the prior art as the close-in region of an antenna. The angular field distribution of the antenna is dependent upon distance from the antenna The electromagnetic wave intensity diminishes with distance R from the source at a rate of 1/R², so it stands to reason that in order to minimize the power consumption of wireless transmitting sensors that they be located as close as possible to the antenna with which they are communicating.

A tire pressure measurement system may be implemented in a motor vehicle by using the vehicle body as a machine body antenna. This places each tire sensor within the near field of the machine body antenna, reducing its power requirements, while also eliminating the costly installation of individual antennas at or near each wheel on the vehicle.

The initial embodiments of applications using the present invention may incorporate either Frequency Shift Keying (FSK) modulation, Phase Shift Keying (PSK) modulation or Amplitude Shift Keying (ASK) modulation, primarily due to the current availability of transceivers using those modulation schemes. However, the present invention is not limited to these, as other modulation schemes are possible such as carrier-less ultra wideband technology using impulse excitation.

Embodiments of a so-called Smart Antenna System may include summing of various antenna signals in a phase coherent manner, or phase incoherent manner, or time domain multiplexing of the antenna sources and dynamic selection of signal source. A Smart Antenna System using phase information could be employed to locate sensors relative to the smart antenna system. Applications of Smart Antenna Systems may incorporate the present invention with one or more additional tuned antennas to enhance system performance and/or reliability. One embodiment of the Smart Antenna System may use the machine body antenna of the present invention with multiple feed points between the transceiver and the machine body, creating multiple virtual machine body antennae, and a virtual phased array.

Given the geometric complexity of various machine bodies, their emission patterns at various frequencies, and desired wireless device or sensor placement on or near the body, it is desirable that the wireless sensor system using the machine body antenna be able to dynamically adapt its operating frequency or frequencies by sensor to optimize signaling to and from each sensor. Consequently, a signal strength feedback loop may be incorporated from the sensors to the interrogating nodes, and a feed forward frequency selection loop from the node to the individual sensors. With each sensor having its own unique identification (id), combined with the signal strength feedback, and frequency selection feed forward, the interrogating node(s) may dynamically adjust for optimum performance of the machine body antenna on a sensor by sensor basis.

Ideally on machines where specific sensor location information is desired by the interrogating node(s), an automatic scheme for locating the sensors as described above could be used. In the absence of an auto-locating scheme the interrogating nodes will require manual programming of each sensor location.

Using a machine body isolated from ground as an antenna has additional benefits over a conventional tuned antenna for communicating with wireless devices near the machine body. In particular a reduction in signal variance has been observed providing more stability in the signal and thereby enabling the system to operate reliably with a lower signal to noise ratio than a conventional tuned antenna.

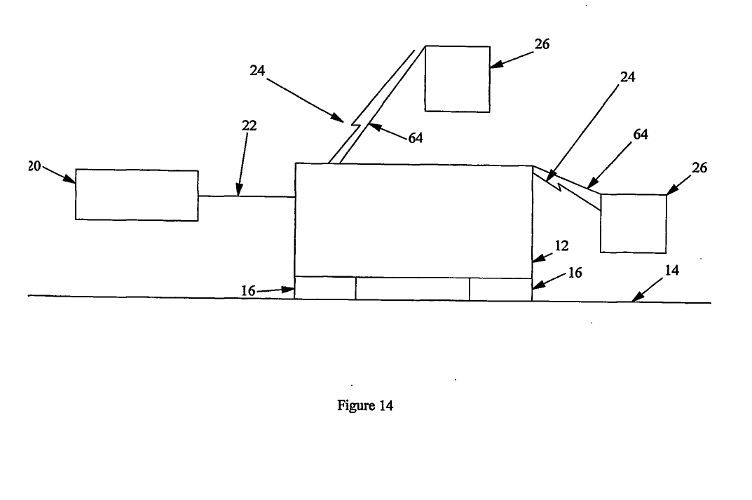

In the further embodiment shown in the block diagram of FIG. 14 the remote wireless devices 26 are connected directly to the machine body 12 by conductive connectors 64, using the machine body 12 as the propagation medium instead of air. This may significantly improve signal strength and signal to noise characteristics of the machine body antenna system, without compromising or hindering the motion of the remote device or sensor.

Experiments were conducted to verify and determine whether an automobile body would act as an efficient antenna connected via the cigarette adapter, and if so, at what frequency. Theoretically, and by way of approximation, an automobile will resonate at an effective half wavelength as follows:

| Frequency | | full wave length | | half wavelength | |
|---|---|---|---|---|---|
| 3 | GHz | 10 | cm | 5 | cm |
| 1 | GHz | 30 | cm | 15 | cm |
| 300 | MHz | 1 | m | 0.5 | m |
| 100 | MHz | 3 | m | 1.5 | m |
| 30 | MHz | 10 | m | 5 | m |
| 10 | MHz | 30 | m | 15 | m |
| 5 | MHz | 60 | m | 30 | m |

Hence it can be estimated, in a first order of approximation, that a medium passenger sedan will radiate at approximately 30 MHz, while a large trailer truck will radiate at approximately 5 MHz. The testing showed that the theoretical prediction is close to the measured results. The peak efficiency occurred at approximately 25 MHz on a 1993 Cutlass Supreme™ sedan using a sensor mounted under the valve stem of one of the tires.

As will be apparent to those skilled in the art in the light of the foregoing disclosure, many alterations and modifications are possible in the practice of this invention without departing from the spirit or scope thereof Accordingly, the scope of the invention is to be construed in accordance with the substance defined by the following claims.

What is claimed is:

1. A communication system for communicating with near field devices using a machine body antenna, the system comprising:
an RF receiver element and an RF transmitter element forming an inter-communicating RF transmitter and receiver pair, and a machine body antenna cooperating therebetween, a near field device in electrical communication so as to cooperate with a first element of said transmitter and receiver pair,
wherein said machine body antenna is electrically isolated from ground and includes an electrically conductive machine frame electrically connected to so as to cooperate with and be excited by a second element of said transmitter and receiver pair,
and wherein said first element is within a near field of said machine body antenna without being in contact with said machine body antenna

2. The apparatus of claim 1 wherein said first element is the transmitter of said transmitter and receiver pair and said second element is the receiver of said transmitter and receiver pair.

3. The apparatus of claim 2 wherein said near field device is a sensor.

4. The apparatus of claim 3 wherein said sensor monitors at least one physical characteristic associated with said machine body antenna.

5. The apparatus of claim 4 wherein said at least one physical characteristic includes pressure.

6. The apparatus of claim 5 wherein said machine body antenna is the body of a vehicle.

7. The apparatus of claim 1 wherein said machine body antenna is the body of a vehicle.

8. The apparatus of claim 6 wherein said sensor is mountable in cooperative association with a pneumatic tire valve of said vehicle.

9. The apparatus of claim 8 wherein said sensor and said transmitter are mounted in a housing and said housing is mountable to, so as to cooperate with, a base end of a valve stem of said tire valve.

10. The apparatus of claim 9 wherein said housing includes a cupped upper end shaped to fit conformably over said base end, and wherein a cavity is formed in said housing underneath said upper end and sized to house said sensor and said transmitter.

11. The apparatus of claim 10 wherein said sensor cooperates with said base end of said valve stem via an aperture in said upper end of said housing.

12. The apparatus of claim 1 further comprising a processor cooperating with said second element for processing information exchanging between said transmitter and receiver pair.

13. The apparatus of claim 1 wherein said first and second elements are both transceivers.

14. The apparatus of claim 12 wherein said machine body antenna is a machine having an electrical system and wherein said processor and said second element are powered by a de-mountable electrical coupling to said electrical system of said machine body antenna.

15. The apparatus of claim 7 further comprising a processor cooperating with said second element for processing information exchanging between said transmitter and receiver pair and wherein said machine body antenna includes a vehicle having an electrical system and wherein said processor and said second element are powered by a de-mountable electrical coupling to said electrical system of said vehicle.

16. The apparatus of claim 15 wherein said coupling is adapted to removably couple with an electrical accessory power port in said vehicle.

17. The apparatus of claim 16 wherein said power port is a cigarette lighter plug-in port in a dashboard of said vehicle.

18. The apparatus of claim 4 wherein said second element includes a processor and an associated display for displaying processed information correlated to said physical characteristic.

19. A communication antenna for communications with a near field device using at least one transmitter and receiver pair, the antenna comprising:
a machine body antenna which is electrically isolated from ground and includes an electrically conductive machine frame, and which, when in electrical communication with one transmitter or receiver element of the transmitter and receiver pair, is excited so as to enable communication between the transmitter and receiver pair when the other of the transmitter or receiver elements is in electrical communication with the near field device and mounted within the near field of said machine body antenna without being in contact with said machine body antenna.
